(19) United States
(12) Patent Application Publication
(10) Pub. No.: US 2026/0146502 A1
(43) Pub. Date: May 28, 2026

(54) FRAMES INCLUDING RETAINING MEMBERS FOR RETAINING SCREENS

(71) Applicant: RS FlexScreen, LLC, Hialeah, FL (US)

(72) Inventor: Joseph A. Altieri, JR., Pittsburgh, PA (US)

(21) Appl. No.: 19/401,025

(22) Filed: Nov. 25, 2025

Related U.S. Application Data
(60) Provisional application No. 63/724,496, filed on Nov. 25, 2024.

(51) Int. Cl. E06B 9/52

(52) U.S. Cl. CPC E06B 9/52; E06B 2009/527

(57) ABSTRACT

A window frame comprising an upper frame member, a lower frame member opposite the upper frame member, a first side member extending between the upper frame member and the lower frame member, a second side member opposite the first side member and extending between the upper frame member and the lower frame member. One or more retaining members provided within an upper portion of at least one of the first side member or the second side member. The one or more retaining members are configured to apply a compressive force to a window screen sufficient to retain the window screen in a vertically displaced position in the window frame.

### RELATED APPLICATIONS

This application claims the benefit of Priority Under 35 U.S.C. 119(e) to U.S. Provisional Patent Application No. 63/724,496, entitled “Frames Including Retaining Members for Retaining Screens,” filed Nov. 25, 2024, which is hereby fully incorporated by reference herein.

### TECHNICAL FIELD

The disclosure relates generally to window systems for positioning removable screens and, more specifically, to window frames including retaining members for retaining window screens in position.

### BACKGROUND

Window screens are often used to keep insects, leaves, birds, and debris from entering a building or other structure while permitting the inflow of fresh air. Most window screens are formed from a fiberglass mesh or netting held taut and supported by an aluminum frame. Other common mesh materials include nylon, polyester, bronze, stainless steel, aluminum, copper, brass, and galvanized steel. Other common frame materials include wood, steel, and vinyl, sometimes in combination with each other and/or aluminum, though over the years other materials have been tried, including rubber, fiberglass, and closed-cell foams. Some window screens have no frames, but are mesh material that is made to roll out from a spool and then be held taut across an opening by fastening the screen mesh to a window frame itself.

Despite the maturity of the art of screen making, some improvements are still needed. One of those needed improvements relates to a type of window screen which is in common use in modern residential and commercial construction. This screen type is referred to herein as a “groove-attachment screen.” The groove-attachment screen is held in place in a window opening defined by a window frame in which it is intended to be used by way of parallel sides of the screen frame fitting within receiving grooves running along two parallel sides of the window frame. One or more retaining members typically project from one of the two vertical sides of the screen frame. In some cases, the receiving grooves are located on the vertical sides of the window frame, while in others they are located on the top and bottom sides of the window frame. Typically, one of the receiving grooves is a full-groove, i.e., a u-shaped groove, while the other receiving groove may be either a full groove or a partial groove i.e., a groove having a bottom seating side and either just one retaining wall side or two retaining wall sides of unequal height.

During installation of a conventional groove-attachment screen, the side of the screen frame which has the retaining member or retaining members is received within one of the receiving grooves of the window frame. The body of the screen is then rotated into a plane defined by the receiving grooves while the screen frame having the retaining member or retaining members is pressed into the receiving groove of the window frame to compress the retaining member or retaining members. This compression allows the screen frame to slip past a lip of the respective receiving groove. Thereafter, the person installing the window frame stops pressing against the retaining member of the screen frame so that the retaining member or retaining members are released to be seated against the receiving groove. The screen is removed by reversing the installation process.

One problem with the conventional groove-attachment screen is that it can be difficult to install and to remove from the receiving grooves of a window frame. This is especially true for difficult to reach windows where it is difficult to simultaneously compress all of the retaining members along one side of the screen frame while fitting or withdrawing the opposing side of the screen frame into or out of its receiving groove. This problem is often aggravated when the corners of the screen frame lack sufficient rigidity to maintain the screen frame in a single plane.

Accordingly, a need exists for improved screen systems which can easily accommodate screens into a window frame.

### SUMMARY

In one embodiment, a window frame includes: an upper frame member; a lower frame member opposite the upper frame member; a first side member extending between the upper frame member and the lower frame member; a second side member opposite the first side member and extending between the upper frame member and the lower frame member; and one or more retaining members provided within an upper portion of at least one of the first side member or the second side member, where the one or more retaining members are configured to apply a compressive force to a window screen sufficient to retain the window screen in a vertically displaced position in the window frame.

In another embodiment, a window system includes: a window frame including: an upper frame member; a lower frame member opposite the upper frame member; a first side member extending between the upper frame member and the lower frame member; a second side member opposite the first side member and extending between the upper frame member and the lower frame member; and one or more retaining members provided within an upper portion of at least one of the first side member or the second side member; and a screen received within the window frame, wherein the window screen is retained in the upper portion of the window frame by the one or more retaining members.

The window screen may be retained in an upper portion of a window frame by the one or more retaining members, where the window screen may include a screen frame and a screen mesh affixed to the screen frame. In one embodiment, the window screen is a flexible partial screen. The one or more retaining members may apply a retention force to the window screen below a threshold that would cause sagging of a screen mesh.

In some embodiments, the retaining members may include a resilient arcuate body having a first end and a second end. Fingers may extend from the respective ends for engagement with the window frame. In some embodiments, the retaining members have a length between about 50 mm and about 100 mm. The retaining members may be formed from a resilient material selected from metal, polymer, composite, or fiberglass.

According to one embodiment, the first side member defines a first receiving groove having a first receiving groove base and the second side member defines a second receiving groove having a second receiving groove base. The fingers of a retaining member may be received in respective apertures in the first receiving groove base or the second receiving groove base. In some embodiments, the retaining members are installed under tension.

According to one embodiment, a first plurality of retaining members is spaced along the first receiving groove and a second plurality of retaining members is spaced along the second receiving groove. The retaining members in the first plurality of retaining members may have different degrees of resilience from each other and the retaining members in the second plurality of retaining members may have different degrees of resilience from each other. In one embodiment, the retaining member with a highest degree of resilience from the first plurality of retaining members is located closer to the upper frame member than any other retaining member from the first plurality of retaining members and the retaining member with the highest degree of resilience from the second plurality of retaining members is located closer to the upper frame member than any other retaining member from the second plurality of retaining members.

One embodiment of a window frame comprises an upper frame member, a lower frame member opposite the upper frame member, a first side member extending between the upper frame member and the lower frame member, and a second side member opposite the first side member and extending between the upper frame member and the lower frame member. The first side member may define a first receiving groove for receiving a window screen and the first side member may include a first receiving groove base that, for example, defines a first plurality of apertures. The second side member may define a second receiving groove for receiving the window screen and include a second receiving groove base that, for example, defines a second plurality of apertures. The frame may include a plurality of retaining members for retaining the window screen in a vertically displaced position. The retaining members may include a resilient arcuate body having a first end and a second end. A retaining member may also include a first finger extending radially inward at the first end of the resilient arcuate body, where the first finger extends into a respective aperture in the first receiving groove base or the second receiving groove base. A retaining member may also include a second finger extending radially inward at the second end of the resilient arcuate body, where the second finger extends into a respective second aperture in the first receiving groove base or the second receiving groove base. The plurality of retaining members may be installed under tension. In some embodiments, the plurality of retaining members are adapted to engage opposite sides of the window screen to apply a retaining force to the window screen when the window screen is seated in the first receiving groove and the second receiving groove against the plurality of retaining members.

Another general aspect of the present disclosure includes a method for screen retention. The method may include providing a window frame including an upper frame member, a lower frame member, a first side member, and a second side member, the first and second side members each defining a receiving groove. The method also includes seating a screen within the receiving grooves of the window frame. The method also includes applying a compressive force to the screen via one or more retaining members disposed within an upper portion of at least one of the first side member or the second side member, where the compressive force retains the screen in a vertically displaced position.

According to one embodiment of the method, one or more retaining members is installed under tension. The retaining members may include a resilient arcuate body. The retaining members may engage the screen to maintain the screen in the upper position. In some embodiments, the screen is a flexible partial screen.

These and additional features provided by the embodiments described herein will be more fully understood in view of the following detailed description, in conjunction with the drawings.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1A is a diagrammatic representation of a front view of a window screen received within a window frame, according to one or more embodiments;

FIG. 1B is a diagrammatic representation of a front view of a window screen positioned in an upper portion within a window frame, according to one or more embodiments;

FIG. 2 is a diagrammatic representation of one embodiment of a portion of a screen seated in a receiving groove, according to one or more embodiments.

FIG. 3 is a diagrammatic representation of a retaining member, according to one or more embodiments; and

FIG. 4 is a diagrammatic representation of the retaining member within a window frame, according to one or more embodiments shown and described herein.

FIG. 5 is a diagrammatic representation of a window screen for installation in a window frame, according to one or more embodiments;

FIG. 6 is a diagrammatic representation of a window screen, according to one or more embodiments shown and described herein;

FIG. 7 is a diagrammatic representation of a partial cross-sectional side view of a side member of the window screen of FIG. 6, according to one or more embodiments.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

The present disclosure provides an improved window frame and groove-attachment window screen which solves one or more of the problems described above with regard to conventional groove-attachment window screens. In some embodiments, the window screens of the present disclosure may be easily inserted into and removed from the groove. For example, some embodiments of the present disclosure may use flexible window screens. A flexible screen has a screen frame that can deform to allow the screen to be installed or removed from a window frame and then return to its original shape. The window screens of the present disclosure include a screen frame and a screen mesh. The screen frame is shaped such that it at least partially covers a window opening for which it is designed. The window screens of the present disclosure may be shaped as rectangles in commonly used embodiments, though any shape taken by a window opening may also be employed within the context of the present disclosure. Additionally, although reference is made to the screens being window screens being positioned within a window opening or a window frame, it should be appreciated that the present disclosure is equally applicable to door screens positionable within a door frame or a door opening.

In certain embodiments, the screen may comprise a partial configuration that occludes only a selected portion of the window opening (e.g., approximately one-quarter, one-half, one-third, or other fractional coverage). Some partial screens have significant functional constraints. For instance, a user may desire to reposition a partial screen covering the lower region of a single-hung or double-hung window to maintain unobstructed access for an extended duration. However, due to the relatively unconstrained nature of some screens, particularly flexible screens, within the window frame's receiving groove, the screen may lack sufficient positional stability and tend to return downward under its own weight when raised. Consequently, the user may be compelled to remove and store the screen to achieve prolonged clearance of the lower window section. Moreover, some partial screens are generally unsuitable for installation in the upper region of the window as gravitational forces similarly cause the screen to descend.

Thus, the present disclosure is further related to retaining the position of partial screens, including flexible partial screens, in a vertically displaced position in a window opening. Embodiments described herein may be directed to a window system including a window frame and a window screen. The window system may include an upper frame member, a lower frame member opposite the upper frame member, a first side member extending between the upper frame member and the lower frame member, a second side member opposite the first side member and extending between the upper frame member and the lower frame member, and one or more retaining members provided within an upper portion of at least one of the first side member or the second side member. The window screen is received within the window frame. The window screen is retained in the upper portion of the window frame or other vertically displaced position by the one or more retaining members. Various embodiments of the window system and the operation of the window system are described in more detail herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

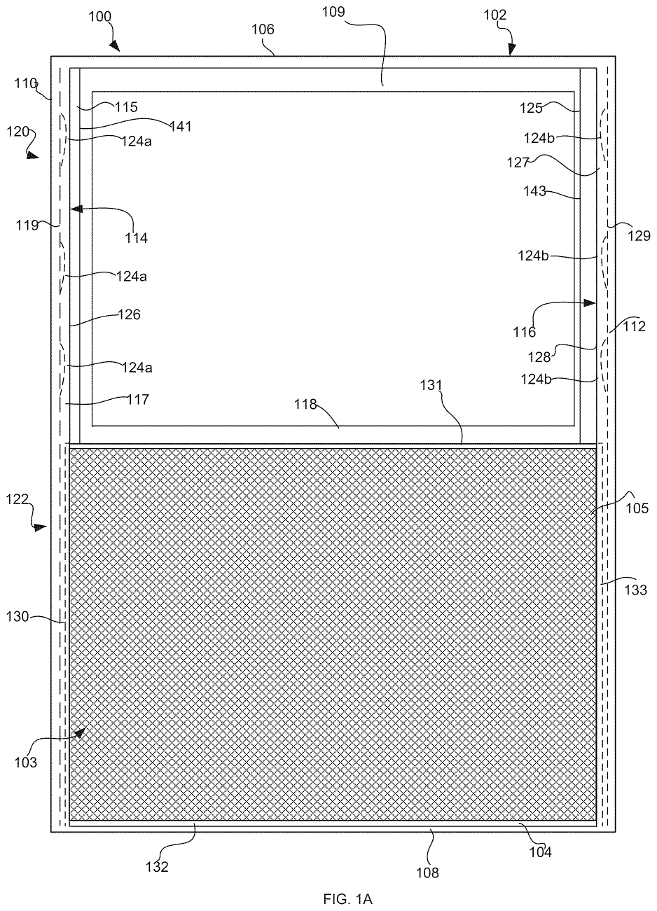

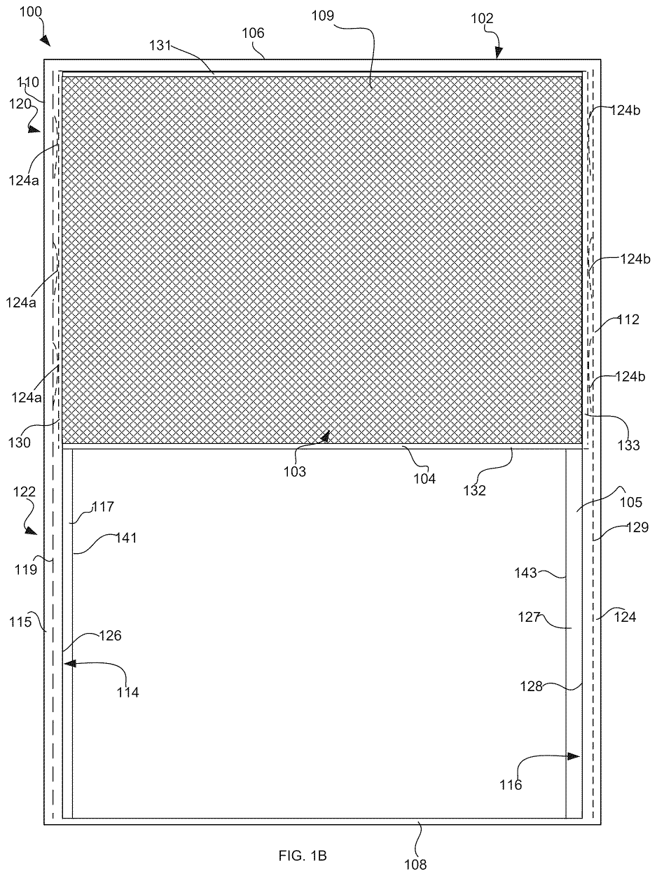

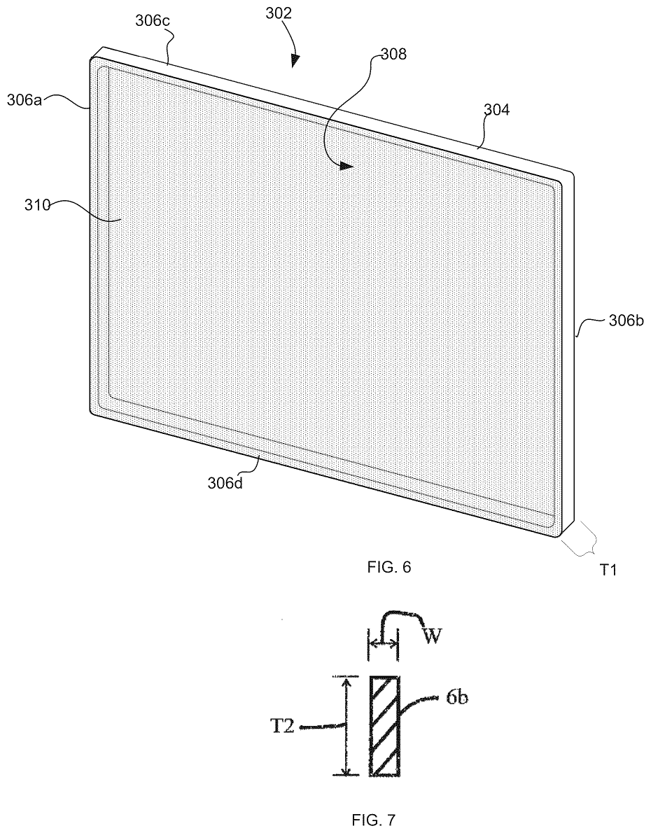

Referring now to FIG. 1A, a system 100 is illustrated including a window frame 102 and a window screen 103. Window screen 103 is a partial window screen (e.g., a half window screen) and includes a screen frame 104 to which a screen mesh 105 is fixedly attached. In various embodiments, window screen 103 may be a flexible partial window screen in which one or more of the frame members has spring-like characteristics to allow the window screen 103 to be deformed for installation in or removal from frame 102. In even more particular embodiments, window screen 103 may be a flexible partial screen formed as discussed below in conjunction with FIG. 6. In other embodiments, window screen 103 is a rigid screen.

The window frame 102 includes an upper frame member 106, a lower frame member 108 opposite the upper frame member 106, a first side member 110 extending between the upper frame member 106 and the lower frame member 108, and a second side member 112 opposite the first side member 110 extending between the upper frame member 106 and the lower frame member 108. In some embodiments, window frame 102 is the frame to a single-hung or double-hung window having an upper sash 109 and a lower sash (obscured in the view of FIG. 1A). In a single-hung window, upper sash 109 is fixed and the lower sash can be raised to open the lower portion 122 of the window. In a double-hung window, upper sash 109 and the lower sash are movable to respectively open/close the upper portion 120 and lower portion 122 of the window.

A first receiving groove 114 is formed in the first side member 110, and a second receiving groove 116 is formed in the second side member 112. The first receiving groove 114 and the second receiving groove 116 extend between the upper frame member 106 and the lower frame member 108. Each of the first receiving groove and second receiving groove may be defined by a respective first receiving groove wall 115, 125, second receiving groove wall 117, 127, and receiving groove base 119, 129 that extends between the first receiving groove wall 115, 125 and second receiving groove wall 117, 127. Window frame 102 may further include, in some embodiments, an upper receiving groove and a lower receiving groove.

A center frame member 118 may be positioned substantially between the upper frame member 106 and the lower frame member 108, and extends between the first side member 110 and the second side member 112. The center frame member 118 separates an upper window portion 120 defined by the upper frame member 106, the center frame member 118, the first side member 110, and the second side member 112, and a lower window portion 122 defined by the lower frame member 108, the center frame member 118, the first side member 110, and the second side member 112. In some embodiments, the lower member of upper sash 109 provides the center frame member 118.

As shown in FIG. 1A, the window screen 103 is shown received in the lower window portion 122 below the frame center and, thus, in a lower position. The window screen 103 includes a first side member 130 extending between an upper member 131 and a lower member 132 and a second side member 133 opposite the first side member 130. The first side member 130 is received within the first receiving groove 114, and the second side member 133 is received within the second receiving groove 116. In some embodiments of the present disclosure, the width of at least one of the side members 130, 133 is less than the depth of its corresponding receiving groove 114, 116 so that the side member 130, 133 is not visible to an observer who is viewing the window screen 103 with a line of vision that is perpendicular to window screen 103.

As shown in FIG. 1A, one or more retaining members 124 are provided in one or both of the first receiving groove 114 of the first side member 110 and the second receiving groove 116 of the second side member 112 within an upper window portion 120. In embodiments, a plurality of first retaining members 124a are provided in the first receiving groove 114 formed in the first side member 110, and a plurality of second retaining members 124b are provided in the second receiving groove 116 formed in the second side member 112 (retaining members 124a, 124b may generally be referred to as retaining members 124). However, it should be appreciated that any number of retaining members 124 may be provided. Additionally, it should be appreciated that the number of first retaining members 124a in the first receiving groove 114 need not be equal to the number of second retaining members 124b in the second receiving groove 116.

Referring still to FIG. 1A, three first retaining members 124a are provided in the first receiving groove 114. The first retaining members 124a generally have an arcuate shape and extend from the first side member 110. The first retaining members 124a do not extend past an inner edge 126 of the second receiving groove wall 117. As such, the first retaining members 124a are concealed from a front view of the window frame 102. In other embodiments, one or more of the first retaining members 124a may extend past edge 126, but do not extend past inner edge 141 of first receiving groove wall 115. Thus, when no screen is installed in the upper portion, one or more of the first retaining members 124a may be visible from one side of the window but not the other. While, in the illustrated embodiment, the first retaining members 124a are equidistantly spaced apart from one another, they may be otherwise spaced. Further, there may be fewer or more first retaining members 124a.

Similarly, referring to FIG. 1A, three second retaining members 124b are provided in the second receiving groove 116. The second retaining members 124b generally have an arcuate shape and extend from the second side member 112. The second retaining members 124b do not extend past an inner edge 128 of the second receiving groove wall 127. As such, the second retaining members 124b are concealed from a front view of the window frame 102. In other embodiments, one or more of the first retaining members 124b may extend past edge 128, but do not extend past inner edge 143 of first receiving groove wall 125. Thus, when no screen is installed in the upper portion, one or more of the second retaining members 124b may be visible from one side of the window but not the other. While, in the illustrated embodiment, the second retaining members 124b are equidistantly spaced apart from one another, they may be otherwise spaced. Further, there may be fewer or more second retaining members 124b.

In the embodiment of FIG. 1A, the second retaining members 124b are vertically aligned with respective first retaining members 124a. However, it should be appreciated that the above is only one example. Accordingly, the spacing of the first retaining members 124a and the second retaining members 124b may differ from that specifically depicted herein.

It should be appreciated that the structure, formation, and function of the first retaining members 124a may be the same as that of the second retaining members 124b. Therefore, reference to the structure of the first retaining members 124a is equally applicable to the structure of the second retaining members 124b.

As described in more detail herein, the retaining members 124 have a degree of resilience determined by the manner in which the retaining members 124 are fixed to the window frame 102 and/or the formation, e.g., material, of the retaining members 124. Accordingly, each of the first retaining members 124a may have a different degree of resilience. Similarly, each of the second retaining members 124b may have a different degree of resilience. For example, the retaining members 124 located closer to the upper frame member may have a higher degree of resilience, i.e., requires greater force to deform, as compared to the retaining members 124 located closer to the center frame member 118. In another embodiment, retaining members 124 that are closest to the middle of side members 130, 133 may be configured to apply the least amount of compressive force to the screen frame. This can account for the fact that the weakest point of side members 130, 133 (the part least resistant to deflection from side forces) is near the middle between upper member 131 and lower member 132. When configuring a window to accommodate a flexible screen, the retaining members may be configured through selection of material, form factor and setting of initial installed curvature so that the applied retention force does not distort the screen to an extent that causes perceptible sagging of the mesh.

As illustrated in FIG. 1B, the window screen 103 is movable to an upper position to cover upper window portion 120. In this position, first retaining members 124a are compressed between the receiving groove base 119 and the facing surface of side member 130 and second retaining members 124b are compressed between the receiving groove base 129 and the facing surface of side member 133. Window screen 103 is thus retained in the upper position by the retaining members 124 that applies a retaining force on side members 130, 133 of the window screen 103.

The retaining members 124 may thus assert a compressive force on the screen frame 104 to help retain the screen's vertical position in the window frame. While FIG. 1B illustrates retaining members 124 being used to retain window screen 103 in a fully raised position, retaining members 124 may be configured to retain a window screen in other positions in which the screen frame is vertically displaced from a fully lowered position (e.g., positions in which lower member 132 is not bottomed out in window frame 102).

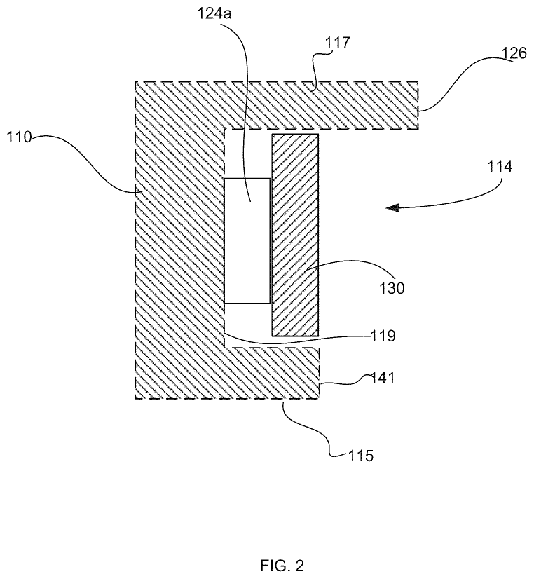

FIG. 2 illustrates a cross-sectional view of one embodiment of a portion of screen 103 seated in receiving groove 114. Receiving groove 114 is a partial groove having a first receiving groove wall 115 and second receiving groove wall 117 of unequal lengths. In other embodiments, the receiving grooves may be full receiving grooves having seating walls of equal lengths. Here, the side member 130 is seated in the receiving groove with a retaining member 124 compressed between side member 130 and the receiving groove base 119. The width of side member 130 is less than the depth of receiving groove 114. As such, the side members of screen frame 104 do not obscure the line of sight through the window.

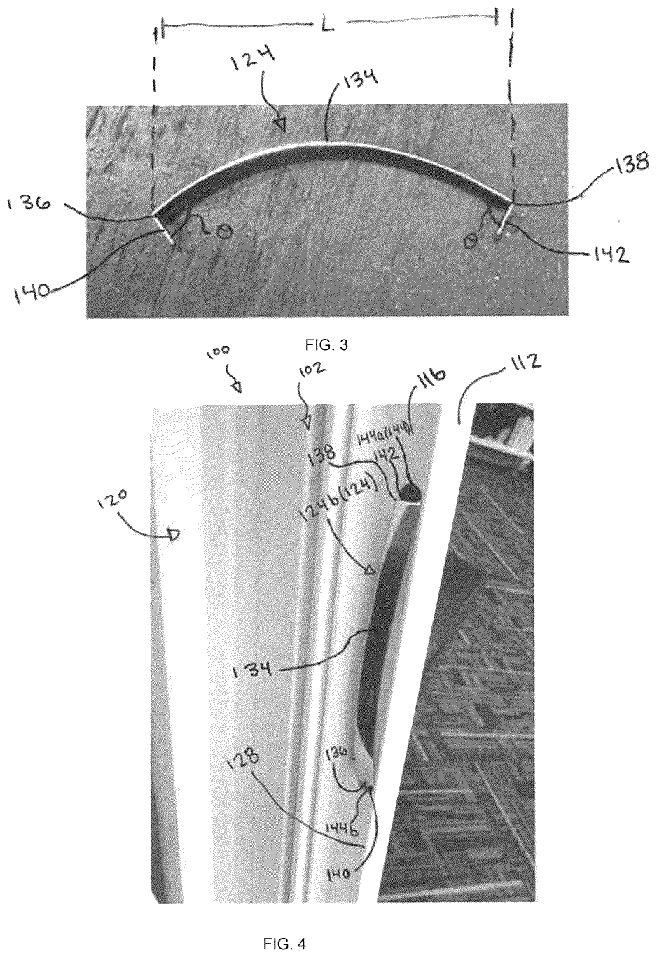

Referring now to FIG. 3, a retaining member 124 according to one embodiment is shown apart from the window frame 102. The retaining member 124 includes a body 134 having a first end 136 and a second end 138 opposite the first end 136. The body 134 has a length L extending between the first end 136 and the second end 138. As shown, the body 134 is curved. In embodiments, the length L is equal to or less than 150 mm. In embodiments, the length L is equal to or less than 100 mm. In embodiments, the length L is equal to or less than 50 mm. In embodiments, the length L is equal to or greater than 50 mm and less than or equal to 100 mm. In embodiments, the length L is 80 mm+/−20%. In embodiments, the length L is 80 mm+/−10%. In embodiments, the length L is 80 mm+/−5%.

A first finger 140 extends from the first end 136 of the body 134, and a second finger 142 extends from the second end 138 of the body 134. The first finger 140 and the second finger 142 each extend radially inwardly from the body 134 at an angle θ relative to the body 134. In embodiments, the angle θ is equal to or less than 130 degrees. In embodiments, the angle θ is equal to or less than 110 degrees. In embodiments, the angle θ is equal to or less than 90 degrees. In embodiments, the angle θ is equal to or less than 70 degrees. In embodiments, the angle θ is equal to or less than 45 degrees. In embodiments, the angle θ is equal to or greater than 45 degrees and less than or equal to 130 degrees. In embodiments, the angle θ is 90 degrees+/−20%. In embodiments, the angle θ is 90 degrees+/−10%. In embodiments, the angle θ is 90 degrees+/−5%.

In embodiments, apertures are formed in the receiving groove bases (e.g., receiving groove base 119, receiving groove base 129) to receive the first finger 140 and second finger 142 of a respective restraining member 124. The apparatus for receiving first finger 140 and second finger 142 of a respective restraining member 124 may be spaced at a distance greater than the unloaded (free arch) distance L. Thus, retraining members 124 may be installed in tension. Thus, the natural restoring force of the retraining member 124 will help retain the fingers in the apertures.

The retaining members 124 are formed from a resilient material such that the body 134 may be deformed upon a force exceeding a predetermined threshold being applied to the body 134. Accordingly, upon the force being applied to the body 134, the curvature of the body 134 is reduced to cause the body 134 to become more linear. Once the force is no longer applied against the body 134 so as to exceed the predetermined threshold, the body 134 returns to the original curved position.

Referring now to FIG. 4, one of the second retaining members 124b is shown positioned within the second receiving groove 116 of the window frame 102. Specifically, the second receiving groove 116 has one or more pairs of holes 144 with each pair of holes 144 corresponding to the placement of a respective second retaining member 124b. Accordingly, as shown in FIG. 6, the first finger 140 is received within an upper hole 144a and the second finger 142 is received within a lower hole 144b of the pair of holes 144. The second retaining member 124b is shown in the original installed curved position. As discussed, however, the pair of holes 144 may be spaced further than the free arch length L of retaining member 124. Thus, in the original installed curved position, the retaining member 124 may be in tension.

When the window screen 103 is moved from the lowered position (FIG. 1A) into the upper position (FIG. 1B), the first retaining members 124a and second retaining members 124b abut opposite side members 130, 133 of the window screen 103 to retain the window screen 103 in the upper position. Once the window screen 103 is moved back into the lower position from the upper position using manual force to lower the window screen 103, the retaining members 124b are permitted to return to their original installed curved position. As noted above, the degree of the resilience of the second retaining members 124b may be dictated by the spacing of the holes 144. For example, the spacing between a pair of holes 144 closer to the upper frame member 106 may be less than the spacing between a pair of holes 144 closer to the center frame member 118, or vice versa. This would provide the second retaining member 124b closer to the upper frame member 106 with a stronger resilience, i.e., requiring more force to deform, than the second retraining member 124b closer to the center frame member 118. The above description of operation of the second retaining member 124b is the same as operation of the first retaining member 124a.

The retaining members may be coupled to the window frame in various ways. In an embodiment with a hollow window frame, for example, one of the first finger 140 or second finger 142 of a retaining member 124 be shaped to be inserted into the end of the side member 110, 122 prior to the window frame being fully assembled. That finger becomes captured at the corner of the screen frame when the respective corner is completed. In other embodiments, one or more of the first finger 140 or second finger 142 may be coupled to the base of the respective receiving groove using a screw or other hardware. The finger may include a slot through which the hardware passes to allow the retaining member to compress.

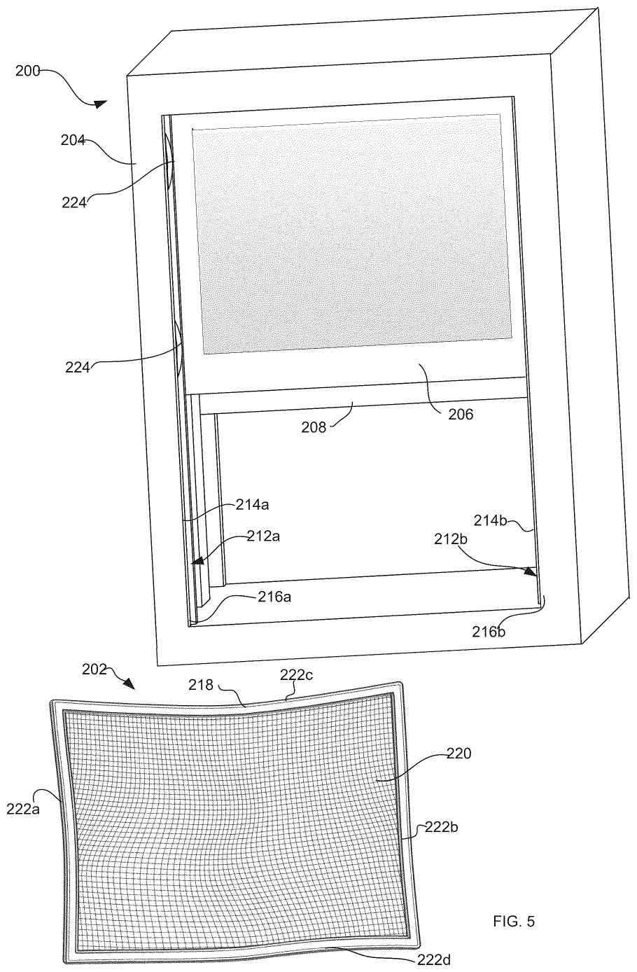

As discussed, in some embodiments, the window screen (e.g., window screen 103) may be a flexible partial window screen. With reference to FIG. 5, a diagrammatic representation of one embodiment of a window 200 and a window screen 202 for installation in window 200 is provided. Window screen 202 is a flexible partial screen. In an even more particular embodiment, window screen 202 may be formed as discussed in conjunction with FIG. 6.

Window 200 comprises a window frame 204, an upper sash 206 and a lower sash 208 (raised behind upper sash 206). In one embodiment, window 200 is a single-hung window in which upper sash 206 is fixed and lower sash 206 can be raised to open window 200. In another embodiment, window 200 is a double-hung window in which both upper sash 206 and lower sash 208 are moveable to respectively open the upper and lower portions of the window.

Frame 204 defines receiving grooves for receiving a screen. In particular, frame 204 defines a first side receiving groove 212a and a second side receiving groove 212b. Each receiving groove may be defined between a respective receiving groove first wall 214a, 214b and a respective receiving groove second wall 216a, 216b. In some embodiments, the window frame may also define one or more of an upper receiving groove or a lower receiving groove.

Window screen 202 comprises a screen frame 218 to which a screen mesh 220 is affixed. Screen frame 218 includes side members 222a, 222b, 222c, and 222d. Screen frame 218 may be deformed by, for example, pushing one or more of side members 222a-222d substantially toward each other by a user in order to either remove the window screen 202 from a window frame 204 or insert the window screen 202 into the window frame 204. In a collapsed position, the window screen 202 is very easy to install or remove from the receiving grooves. as described in more detail herein.

In some embodiments of the present disclosure, the width of at least one of the side members 222a-222d is less than the depth of its corresponding receiving groove that receives the side member so that the side member is not visible to an observer who is viewing the window screen 202 with a line of vision that is perpendicular to the window screen 202. In certain embodiments, the side members 222a-222d have a transverse cross-section having a width-to-thickness ratio of no greater than about 1.5, and in some embodiments no greater than about 1, where the width is measured in the principal plane of the window screen 220. The width-to-thickness ratio disclosed herein also permits the window screen 202 to easily distort and return to the defined shape.

One or more retaining members 224 may be provided in receiving groove 212a and receiving groove 212b. Retaining members 224 may operate similarly to retaining members 124. Retaining members 224 may be configured as discussed and operate similarly to retaining members 124. Thus, for example, flexible partial window screen 202 may be installed in the lower portion or the upper portion of the window. Further, in the arcuate shape of retaining members 224 allows a user to slide window screen 202 from the lower position to the upper position where it will be retained by the retaining members.

Referring now to FIG. 6, there is shown a perspective view of a window screen 302 according to an embodiment of the present disclosure. Window screen 302 may be used as a window screen 103 or window screen 202 in some embodiments. The window screen 302 has a screen frame 304 having four side members 306a-306d that form an aperture 308 therebetween. In some embodiments, the screen frame 304 is fabricated from a single piece of material, as appropriate for the specific implementation at hand. In some embodiments, window screen 302 is manufactured as a partial screen to cover a portion of a window opening, such as the upper portion or lower portion. Window screen 302 may, for example, be a ¼ screen, ⅓ screen, ½ screen or another partial screen that does not fully cover the window opening of a target window.

According to one embodiment, at least one side member 306a-306d of the screen frame 304 is made of a material having spring-like characteristics. As used herein, “spring-like characteristics” means that the material may be substantially deformed or distorted without its shape being permanently altered. As such, the material will return to its originally fabricated shape and dimensions following the deformation. Stated differently, the material from which the window screen 302 of the present disclosure is fabricated is stiff enough to provide the window screen 302 with sufficient rigidity to retain the window screen 302 in the window opening under normal environmental conditions, while at the same time be able to be distorted such that the screen frame 304 is easily removed from that opening. This functionality allows window screen 302 that may be easily deformed and removed from the window opening in which it is placed without permanently deforming the window screen 302. Further, by adopting a defined shape, the side members 306a-306d of the window screen 302 need not force itself against the window frame into which it is inserted. Suitable materials for the screen frame 304 include, without limitation, metals (e.g., steel, stainless steel, aluminum, bronze, copper, brass), polymers, composites, fiberglass, and wood.

The screen frame 304 has an overall thickness T1, which includes the thickness of the side members 306a-306d. In one embodiment, the screen frame 304 is constructed of oil tempered flat wire, such as C1065 high carbon spring steel, having a thickness T1 of about 0.09 inches and a thickness of about 0.225 inches. In another embodiment, the dimensions are different and the flat wire has a width of about 0.156 inches and a thickness T1 of about 0.225 inches. In both examples, the wire has a natural round edge and a smooth clean finish and a tensile strength of 150/220 ksi. Further, the width dimensions are provided plus or minus about 0.002 inches and the thickness dimensions are provided plus or minus about 0.005 inches. Of course, those of skill in the art will recognize that other cross-sectional shapes of wire, as well as other materials besides steel, can be used without departing from the scope of the disclosure.

A transverse cross-sectional view of side member 306b of the screen frame 304 is shown in FIG. 7. The side member 306b has a width W and a thickness T2. It is to be understood that the thickness of the side member 306b, e.g. thickness T2, is measured perpendicular to a plane defined by the screen frame 304 and the width of the side members 306b, e.g., width W, is measured parallel to the plane defined by the screen frame 304. As discussed, in some embodiments, the width W is selected to be less than the depth of the receiving groove in which the frame member is to be seated.

Referring again to FIG. 6, the window screen 302 also includes a screen mesh 310 that is fixedly attached to the screen frame 304 so as to cover the aperture 308. The screen mesh 310 may be fabricated from any mesh material that is compatible with the environment in which the window screen 302 is to be used. In some embodiments, the material forming the screen mesh 310 is a light-weight material and/or one that provides easy passage of air and light without being distracting to a person who is attempting to look through the window screen 302. In other embodiments, any mesh materials meeting the above-stated compatibility criteria are within the scope of the present disclosure. Suitable mesh materials include, without limitation, those made from fiberglass, polymers, and metals (e.g., aluminum, steel, stainless steel, brass, bronze, and copper). The size of the screen mesh 310 may be selected based upon the amount of airflow and the size of the insects, debris, etc., that the window screen is intended to exclude. In an embodiment, the screen mesh 310 is constructed of a woven vinyl-coated fiberglass fabric.

In some embodiments, the screen mesh 310 is fixedly secured or fused to the screen frame 304. The screen mesh 310 and screen frame 304 may be fixed together into a single apparatus through various techniques known in the art, such as melting, welding, adhesion, mechanical fastening, or other physical fixation. In some embodiments, the screen mesh 310 and screen frame 304 are both coated in a thermoplastic, such as polyvinyl chloride, nylon, polyethylene, polypropylene, and polystyrene. In those embodiments, the screen mesh 310 and screen frame 304 may be fused together into a single apparatus by melting the thermoplastic coating of each component while they are in contact with one another in a pre-selected shape and allowing the pieces to cool. After cooling, the two components are thus fused together into a single, unitary apparatus.

Additional suitable means of attachment include, without limitation, melting, welding, adhesion, mechanical fastening, or other physical fixation. Example welding techniques include thermal, chemical, radio frequency, electronic, frictional, and injection techniques. Examples of mechanical or physical fixation include adhesives (where the screen mesh 310 is glued to the screen frame 304), tapes (where the screen mesh 310 is secured to the screen frame 304 using double-sided tape), mechanical fasteners (e.g., rivets, nails), or Velcro (with the male Velcro on the screen mesh and the female Velcro on the screen frame 304, or the converse) to bond the screen mesh 310 to the screen frame 304. In certain embodiments, the screen mesh 310 may be folded over onto itself to form a loop. That loop may be sewed in place to form a pocket into which the screen frame 304 may be placed.

When assembled, the window screen 302 adopts a shape that is defined by the window opening that the window screen 302 is to cover. As used herein, that assembled shape of the window screen 302 is referred to as the pre-selected or defined shape. The window screen 302 thus defines a perimeter of that opening into which the window screen 302 may be placed. When assembled as a complete apparatus, the screen mesh 310 and the screen frame 304 share the preselected shape. Within the context of the present disclosure, both the screen frame 304 and the screen mesh 310 together define the preselected shape. Standing alone without the screen mesh 310, the screen frame 304 may adopt a shape that is a relaxed version of the defined shape where the sides of the screen frame 304 bow outward away from the center of the window screen 302. When screen mesh 310 is secured to the screen frame 304 in the defined shape, the screen mesh 310 acts to cinch the screen frame 304 into the defined shape. As described more fully hereinbelow, the window screen 302 possesses this property through the use of a flexible spring-like material for at least one of the side members 306a-306d of the screen frame 304. As such, when the screen frame 304 and the screen mesh 310 adopt the defined shape, both the screen mesh 310 and the screen frame 304 are under tension such that the screen mesh 310 is held substantially taut across the screen frame 304. This functionality allows window screen 302 to be easily deformed and removed from the window opening in which it is placed without permanently deforming the window screen 302. Further, by adopting a defined shape, the sides of the window screen 302 do not force themselves against the window frame into which it is inserted.

Methods of installing the screens of the present disclosure vary depending upon how many of the side portions of the screen frame have the features of being made of a material having spring-like characteristics. For an embodiment having just one such side member (the “featured side member”), one method of installation is as follows. First, the window screen is angled so as to seat the side member of the screen frame that is parallel to the featured side member into its respective receiving groove. Then, as the window screen is rotated into the plane defined by the parallel receiving grooves of the window opening, a lateral force is applied to the featured side causing it to bow into the frame aperture so that the featured side is able to slip by the lip of its receiving groove. The force is then relieved allowing the featured side to move into its receiving groove. Removal of the window screen may be accomplished by applying an outwardly directed force against the screen mesh so as to cause the featured side to bow into the frame aperture. The featured side is then grasped and a lateral force is applied to it so as to bow it out of its receiving groove. The window screen is then rotated and the side member that is parallel to the featured side member is then pulled out of its receiving groove.

In embodiments of the present disclosure having two parallel portions of the screen frame fabricated from a spring-like material, one method of window screen installation is to apply lateral forces to bow both of the side members towards the center of the window screen, position the window screen against the window opening, and then to release the featured sides so that they enter into their respective receiving grooves. A method of removal is the same as described above for the embodiments having only a single featured side member.

In the embodiments of the present disclosure shown in the drawings, the window screens have two sets of parallel sides. It is to be understood, however, that the present disclosure also includes embodiments in which one or two of the side members are arched. Also, in the embodiments of the present disclosure shown in the drawings, the corners of the screen frame are square. However, it is to be understood that the present disclosure includes within its scope embodiments in which one or more of the junctions of the side members are at angles other than right angles and/or are rounded.

From the above, it is to be appreciated that defined herein is a window system including a window frame and a window screen. The window system includes an upper frame member, a lower frame member opposite the upper frame member, a first side member extending between the upper frame member and the lower frame member, a second side member opposite the first side member and extending between the upper frame member and the lower frame member, and one or more retaining members provided within an upper portion of at least one of the first side member or the second side member. The window screen is received within the window frame. The window screen is retained in the upper portion of the window frame by the one or more retaining members.

Further, while embodiments have been discussed primarily in the context of windows and window frames, embodiments may also be used in other applications, such as for door screens.

It will be apparent to those skilled in the art that various modifications and variations can be made to the embodiments described herein without departing from the scope of the claimed subject matter. Thus, it is intended that the specification covers the modifications and variations of the various embodiments described herein provided such modification and variations come within the scope of the appended claims and their equivalents.

What is claimed is:

1. A window system comprising:
a window frame comprising:
an upper frame member;
a lower frame member opposite the upper frame member;
a first side member extending between the upper frame member and the lower frame member; and
a second side member opposite the first side member and extending between the upper frame member and the lower frame member; and
one or more retaining members provided within an upper portion of at least one of the first side member and the second side member, wherein the one or more retaining members are configured to apply a compressive force to a window screen sufficient to retain the window screen in a vertically displaced position in the window frame.

2. The window system of claim 1, wherein each of the one or more retaining members comprises a resilient arcuate body having a first end and a second end, and a pair of fingers extending from the respective ends for engagement with the window frame.

3. The window system of claim 2, wherein each of the one or more retaining members has length between about 50 mm and about 100 mm.

4. The window system of claim 2, wherein each of the one or more retaining members is formed from a resilient material selected from metal, polymer, composite, or fiberglass.

5. The window system of claim 2, wherein:
the first side member defines a first receiving groove having a first receiving groove base;
the second side member defines a second receiving groove having a second receiving groove base; and
wherein the pair of fingers of each of the one or more retaining members is received in a respective pair of apertures in the first receiving groove base or the second receiving groove base.

6. The window system of claim 5, wherein each of the one or more retaining members is installed under tension.

7. The window system of claim 1, wherein:
the first side member defines a first receiving groove having a first receiving groove base;
the second side member defines a second receiving groove having a second receiving groove base;
a first plurality of retaining members is spaced along the first receiving groove; and
a second plurality of retaining members is spaced along the second receiving groove.

8. The window system of claim 7, wherein the retaining members in the first plurality of retaining members have different degrees of resilience from each other and the retaining members in the second plurality of retaining members have different degrees of resilience from each other.

9. The window system of claim 8, wherein the retaining member with a highest degree of resilience from the first plurality of retaining members is located closer to the upper frame member than any other retaining member from the first plurality of retaining members and wherein the retaining member with the highest degree of resilience from the second plurality of retaining members is located closer to the upper frame member than any other retaining member from the second plurality of retaining members.

10. The window system of claim 1, further comprising the window screen, wherein the window screen is a flexible partial screen, wherein the window screen is retained in an upper portion of a window frame by the one or more retaining members, wherein the window screen comprises a screen frame and a screen mesh affixed to screen frame.

11. The window system of claim 10, wherein the one or more retaining members apply a retention force to the window screen below a threshold that would cause sagging of a screen mesh.

12. The window system of claim 10, wherein the one or more retaining members concealed from a front view of the window frame when no window screen is installed.

13. A window frame comprising:
an upper frame member;
a lower frame member opposite the upper frame member;
a first side member extending between the upper frame member and the lower frame member, the first side member defining a first receiving groove for receiving a window screen, the first side member comprising a first receiving groove base, the first receiving groove base defining a first plurality of apertures;
a second side member opposite the first side member and extending between the upper frame member and the lower frame member the second side member defining a second receiving groove for receiving the window screen, the second side member comprising a second receiving groove base, the second receiving groove base defining a second plurality of apertures;
a plurality of retaining members for retaining the window screen in a vertically displaced position, each of the plurality of retaining members comprising:
a resilient arcuate body having a first end and a second end;
a first finger extending radially inward at the first end of the resilient arcuate body, wherein the first finger extends into a respective aperture in the first receiving groove base or the second receiving groove base; and
a second finger extending radially inward at the second end of the resilient arcuate body, wherein the second finger extends into a respective second aperture in the first receiving groove base or the second receiving groove base, wherein the plurality of retaining members are installed under tension, and wherein the plurality of retaining members are adapted to engage opposite sides of the window screen to apply a retaining force to the window screen when the window screen is seated in the first receiving groove and the second receiving groove against the plurality of retaining members.

14. The window frame of claim 13, wherein the plurality of retaining members are concealed from a front view of the window frame.

15. A method of screen retention, the method comprising:
providing a window frame including an upper frame member, a lower frame member, a first side member, and a second side member, the first and second side members each defining a receiving groove;
seating a screen within the receiving grooves of the window frame; and
applying a compressive force to the screen via one or more retaining members disposed within an upper portion of at least one of the first side member or the second side member, wherein the compressive force retains the screen in a vertically displaced position.

16. The method of claim 15, wherein each of the one or more retaining members is installed under tension.

17. The method of claim 16, wherein each of the one or more retaining members comprises a resilient arcuate body.

18. The method of claim 15, comprising sliding the screen from a lower position to an upper position within the window frame, wherein the one or more retaining members engage the screen to maintain the screen in the upper position.

19. The method of claim 15, wherein the screen is a flexible partial screen.

20. The method of claim 15, wherein the one or more retaining members are concealed from a front view of the window frame.
